(19) United States
(12) Patent Application Publication
(10) Pub. No.: US 2013/0211973 A1
(43) Pub. Date: Aug. 15, 2013

(54) INVENTORY SYSTEM FOR STAGERS, DESIGNERS AND CUSTOMERS

(71) Applicant: Patricia M. Tomlinson, Sammamish, WA (US)

(72) Inventor: Patricia M. Tomlinson, Sammamish, WA (US)

(21) Appl. No.: 13/492,558

(22) Filed: Jun. 8, 2012

Related U.S. Application Data
(60) Provisional application No. 61/494,576, filed on Jun. 8, 2011.

(51) Int. Cl. G06Q 10/08

(52) U.S. Cl. CPC G06Q 10/087
USPC 705/28

(57) ABSTRACT

An online web-based, membership-based inventory system for stagers and designers which includes a processor working with a stored program to enable the storage, rental and sale of inventory items, which includes a membership portion for reviewing and accepting membership applications, a warehouse storage of inventory items, a warehouse inventory portion for storing information concerning inventory items available to the membership; a communication portion enabling the membership to access the stored information in the warehouse inventory portion and to select items from available inventory for rent and/or purchase; and an accounting portion for tracking rental or purchase of inventory items from the inventory warehouse.

### TECHNICAL FIELD

The invention relates to an on-line membership-based inventory system for stagers, designers, affiliates and their customers to facilitate/enable the storage, renting and filling of staging inventory.

### BACKGROUND OF THE INVENTION

Stagers and designers which use furniture and other items to carry out their services have problems with inventory. The problems are as follows: (1) finding quality inventory at low enough prices for sale or rent to be used for staging; (2) once inventory is purchased, stagers and designers have to pay for expensive warehouse space, which is usually a long-term expense even when the items are not in the warehouse; (3) managing the inventory is complex, cumbersome and time-consuming; (4) stagers have to pay for expensive insurance policies not well carried to the industry in order to protect them from liability and damage to their inventory; (5) there is not a current resale resource for stagers and designers that is specialized to the profession; as a result, they end up selling to common sources without differentiation as to the benefits of buying lightly used staging and design quality furniture and accessories; (6) there is no resource for renting their furniture independent of having a staging job; as a result when the inventory is not being used by the stager and designer, it becomes an added monthly expense to store and protect.

Accordingly, it would be desirable to have a system by which stagers and designers can share inventory, with specialized on-line resale venue for furniture and accessories, as well as short-term economical storage of items in a warehouse distribution center offering short-term fluctuating rates.

### BRIEF DESCRIPTION OF THE DRAWINGS

FIG. 1 is a website diagram showing the on-line system of the present invention.

FIG. 2 is an illustration of a sample home page used on the website of FIG. 1.

FIGS. 3 and 4 are examples of furniture items used in the system.

FIG. 5 is an overview of the overall on-line process using the present system.

FIG. 6 is an example of a registration form for use of the system.

FIG. 7 is an example of selected merchandise (my cart) as a transaction example in the system.

FIG. 8 is a screen showing billing information for users of the system.

FIG. 9 is a screen showing delivery options for the system.

FIG. 10 is a website diagram showing more details of the on-line system of the present invention.

FIGS. 11-25 are screens from the website.

FIG. 26 is a flow chart which represents the organization of the front end software for the system of the present invention.

FIGS. 27 and 28 are a listing of modules and administration functions for the back end software for the system of the present invention.

### BEST MODE FOR CARRYING OUT THE INVENTION

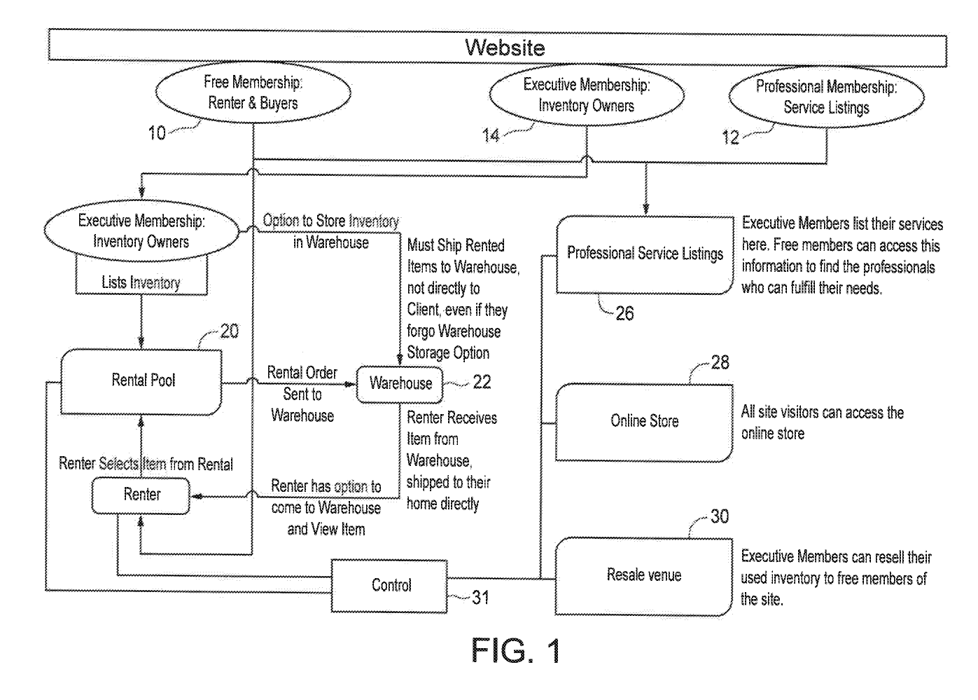

The system is shown generally in FIG. 1. The system provides the following services to its member, including an on-line rental pool for all stagers to share inventory; an on-line resale venue for selling furniture and accessories no longer being used; and a warehouse distribution center that offers short-term fluctuating rates for storage. The system results in the ability for stagers and designers to have a reduced monthly warehouse expense so that they are only paying for storage of items that are actually in the warehouse portion of the system. Further services include: concierge service offering credit card processing for all billing services; on-line monthly customized bookkeeping; on-line inventory management; pickup and delivery services from and to the warehouse; group rates for tailored staging insurance as well as other services; private wholesale buying center for furniture and accessories; warehouse storage of furniture and accessory inventory for all clients as large as a bed or as small as a flower pot; automated tracking process of all inventories throughout the system; and coordination between the warehouse and the on-line inventory system showing what is available and rented out at all times on the stager webpage. All services are managed with an on-line website so each stager has its own page to see what they have available, or rented out. The resale site is promoted to the public as a venue to purchase quality resale stager inventory.

FIG. 1 is a visual representation of the rental pool and the website. The sequence in using the system is as follows:
1. entrance to the website;
2. becoming a member;
3. choosing a membership level.

The free member, shown at 10, has the following options:
(a) browse the rental pool;
(b) browse the classifieds;
(c) fill out payment information on their profile page so they can rent furniture and accessories, or buy resale furniture or accessories from classifieds;
(d) order items from the online store;
(e) fill out a request for staging quote.

The professional member, shown at 12, has the following options:
(a) they can do everything the free member can do, and in addition they can advertise their professional services in our professional services categories listed by city (as long as they relate to the home/garden staging or design industry). They would also post their credit card or payment information on their profile.

The executive member, referred to at 14, has the following options:
(a) this membership level is reserved for accredited stagers and designers only;
(b) they have all of the benefits of the free member;
(c) profile page to list all of their inventory to be made available for rent or sale;
(d) access to storage for their inventory at the SDN warehouse distribution center;
(e) access to concierge services which include automated tracking of their inventory and logging it into our system;
(f) billing for all of their rentals;
(g) itemized statements showing income from rentals/sales and expense from warehouse storage and staging insurance;
(h) access to the wholesale buying center;
(i) referral from our website from on-line referral requests; and
(j) any additional services yet to be determined.
4. Once the executive member posts their inventory, it auto-populates into either the rental pool or the classifieds if they choose.
5. Once a rental order is placed by another member, billing is set up for monthly billing.
(a) The member must either post the total value on the credit card or they can buy renter insurance. The renter insurance protects the renter in case the items are damaged anytime during the process of pulling the items from the warehouse, delivery, while the items are in the home, and during pickup and restocking back at the warehouse.
(b) The items rented will now show up as rented on the stager profile page.
(c) The stager will be credited the income received from the rental items less a percentage we charge and any warehouse expenses they owe.
6. For resale in our classified, the buyer can negotiate via message to the unique ID assigned to the owner of the inventory who is an executive member. The executive member sets the final price and the buyer pays a percentage of the final value of the purchase either via credit card on file or through other authorized payment methods.
7. For the wholesale buying center, the executive member can present their unique ID at the door. When accepted, they can enter the showroom and make catalogue purchases for furniture and accessories or buy what may be available on site.
8. The executive member may resell furniture and accessories purchased at wholesale prices in the homes they have staged or they may list it for rent for 10% of the retail value. This facilitates the process of keeping their inventory up-to-date.

The relationship among the elements, including logic and chronological order, is shown in FIG. 1. The process begins at the step of choosing the membership level. The order may be changed, depending on the service needed by the member of the site.

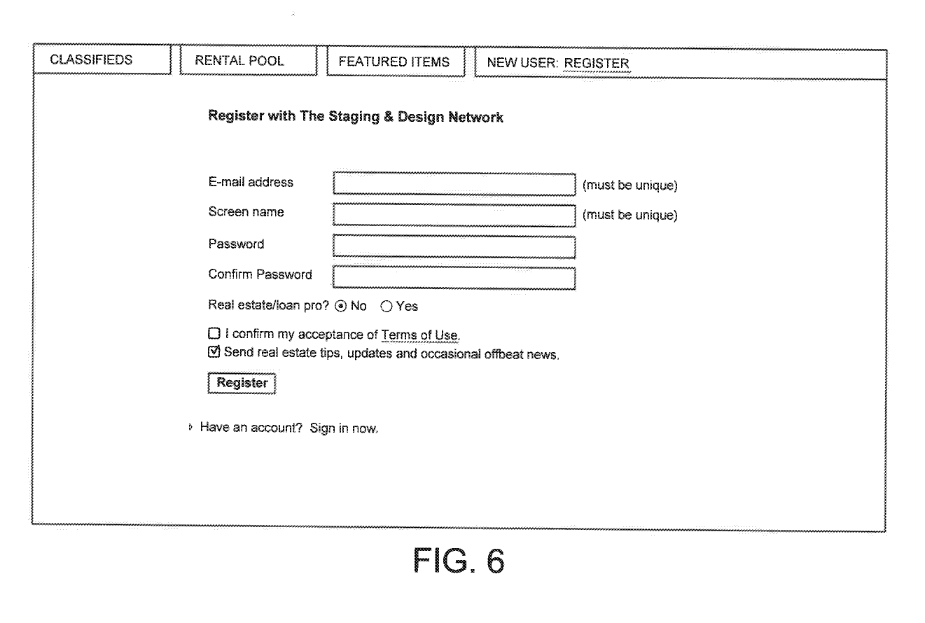

The system works as follows. When a potential member is informed about their choices of membership, they fill out a registration screen, as shown in FIG. 6, he/she then forms a preference among the choices. When they make the choice, they are provided a unique ID, giving them access to participate in the choices available. Once they have the unique ID, they can participate in all services available to that level of membership,

All membership levels are optional. Each membership level has unique services. A necessary element is that all members who use our service will need access to the interne. All three levels of membership (free, executive and professional) have access to the rental pool 20 and the warehouse 22. The executive members have the ability to establish an inventory, shown at 24, in the warehouse 22. If the executive member decides to forego storing their inventory in the warehouse, they must ship the rented items to the warehouse and not directly to the renter.

The professional members have all the benefits of free members and have the opportunity to list their services, as shown at 26. Fees are required per geographic region. The executive members may list services with an additional fee, which gives them the benefits of professional members.

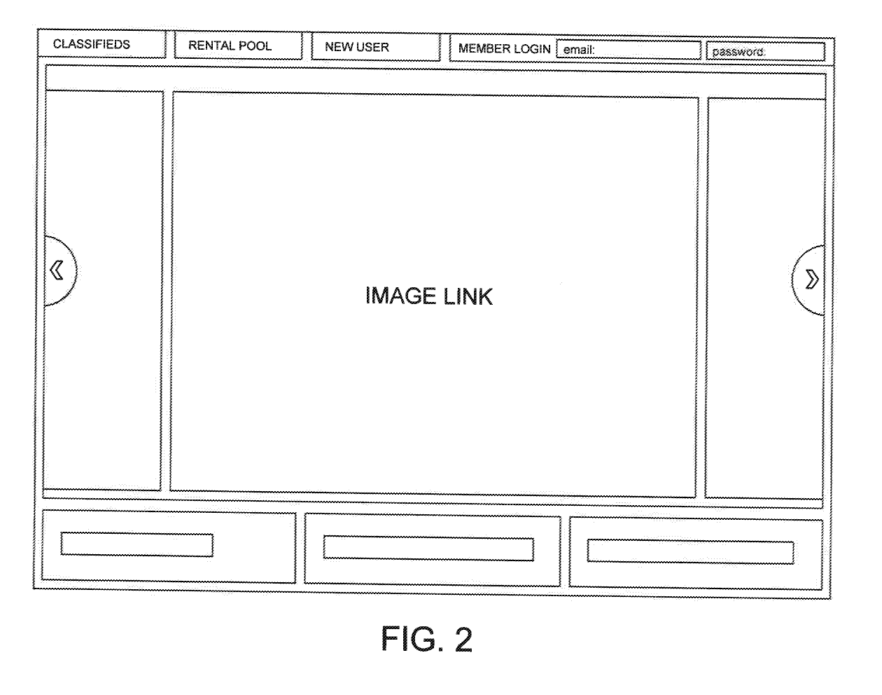

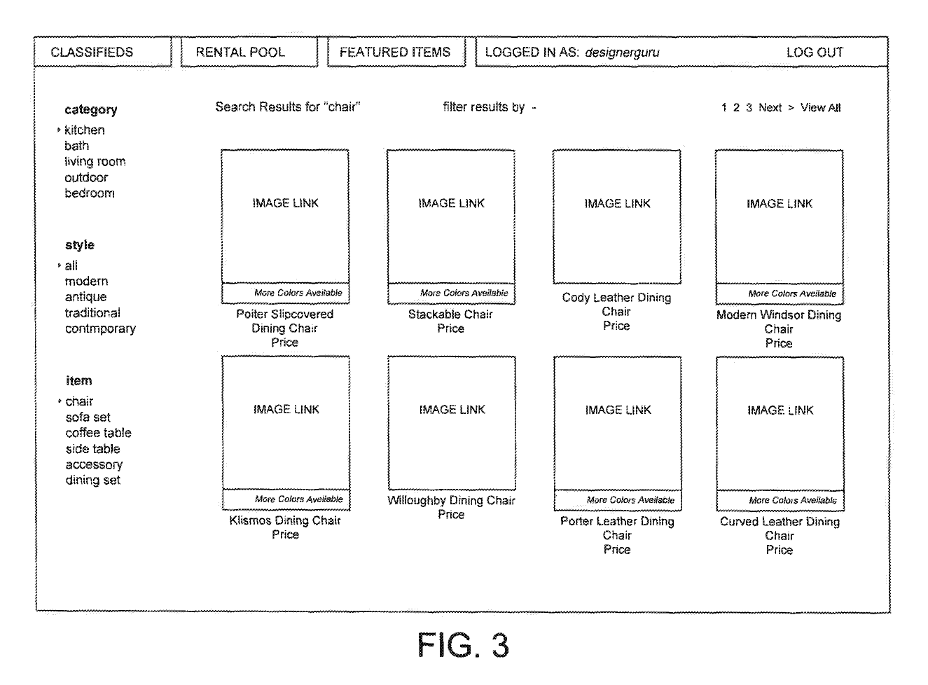

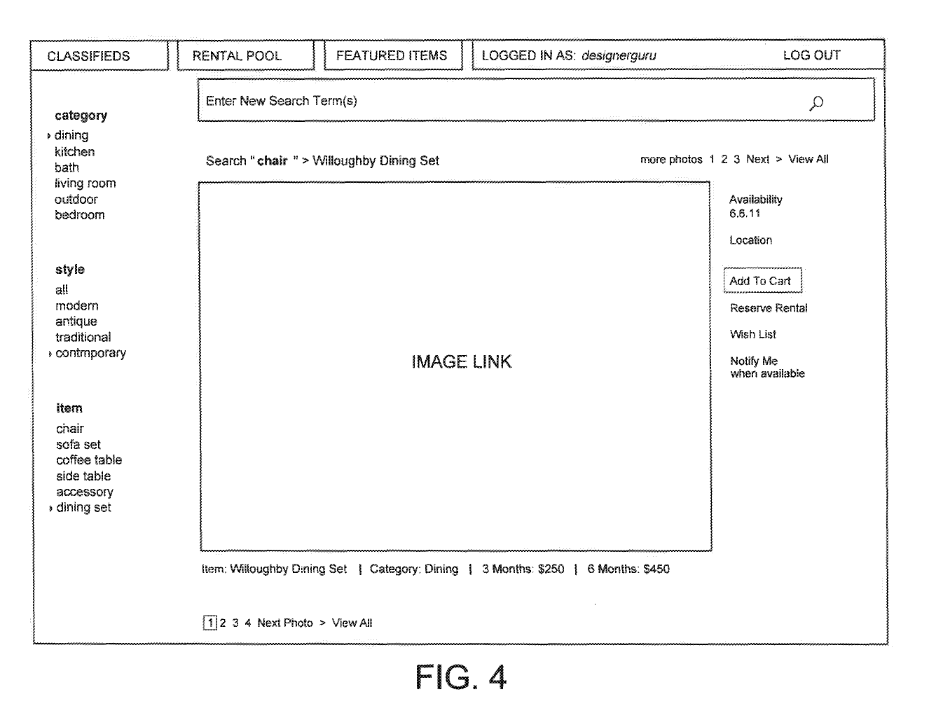

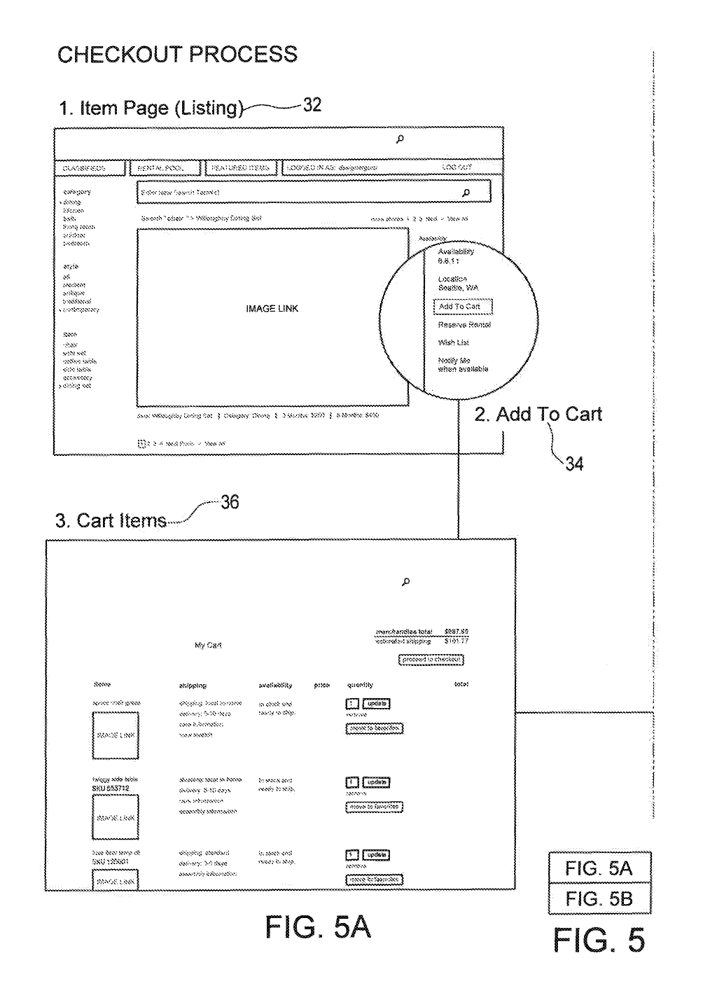

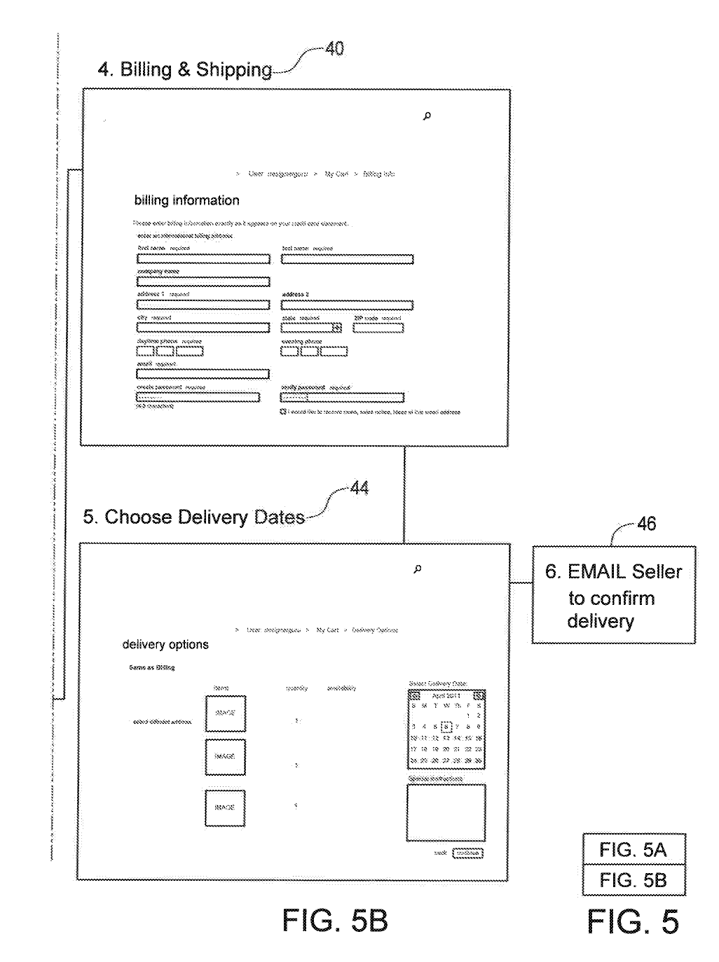

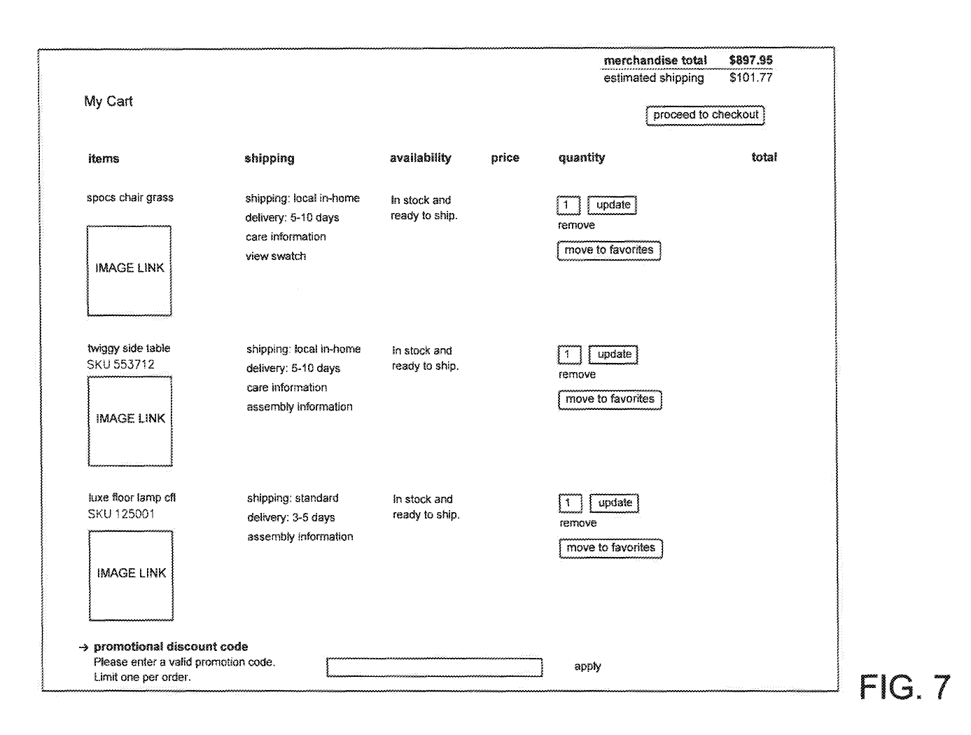

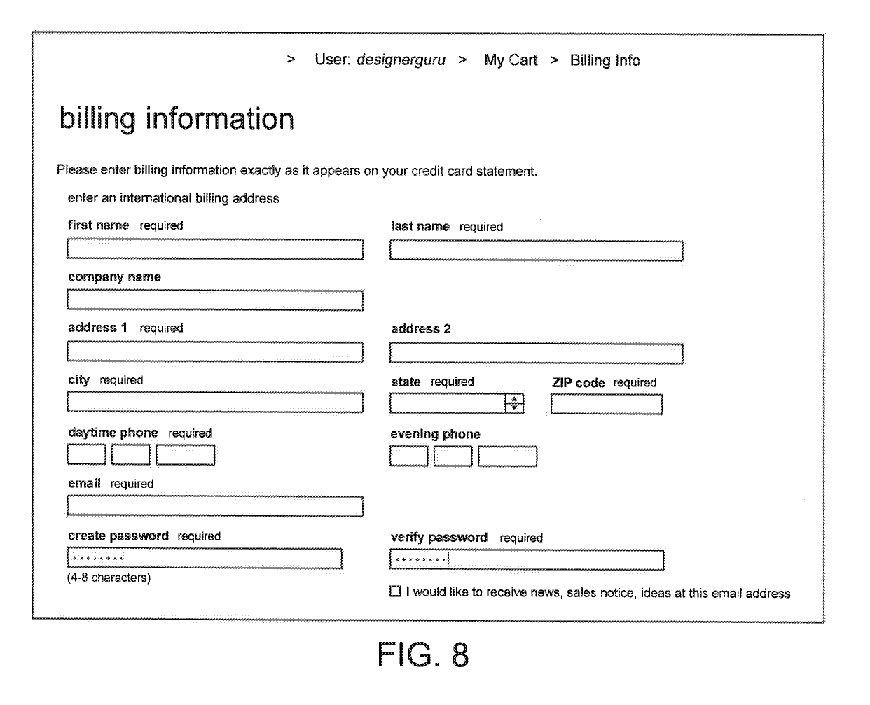

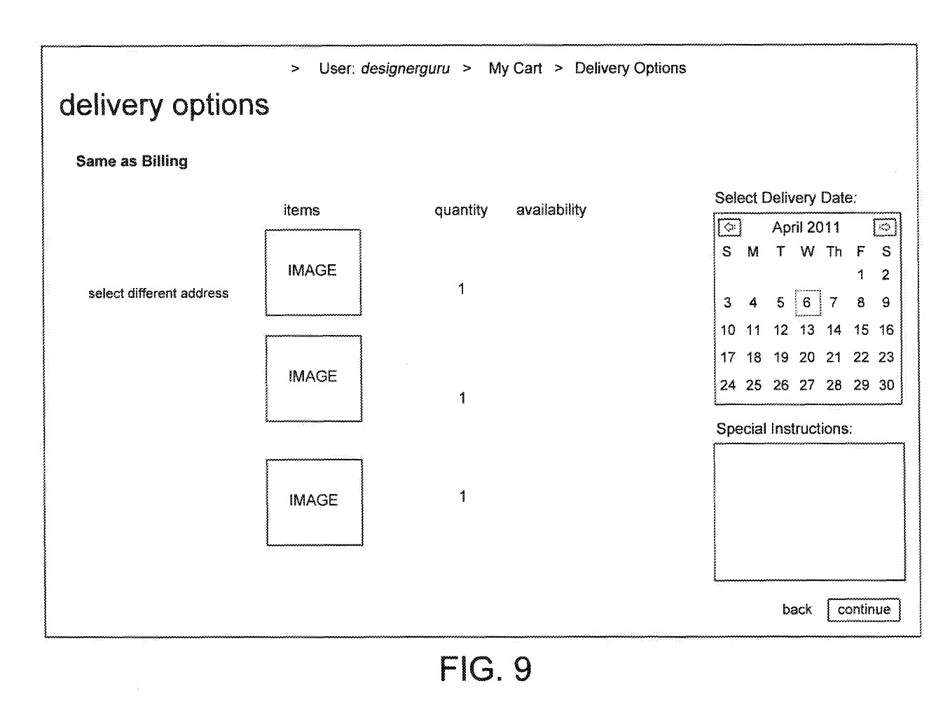

Further, all visitors to the website can access the on-line store, as indicated at 28, while the executive members can resell their used inventory to all three levels of members, including free members, as shown at 30. FIGS. 2-9 show various aspects of the system. FIG. 2 is a sample of a home page for the website. This can of course be varied. FIG. 3 shows one example of furniture items, specifically chairs, which may be a part of the rental pool. The rental pool may be quite large, including various items and accessories, various styles and various categories. FIG. 4 shows a staging example of a combination of possible items in inventory, namely, a dining set. FIG. 5 shows the overall process of the system. A member visitor to the site will first select an item from the inventory (listing), as indicated at 32, and add it to the cart, as represented at 34. An example of a list of cart items selected by the user is shown at 36. The detail of the cart screen is shown in FIG. 7. This of course will change for each transaction. Billing information, shown at 40 in FIG. 5, is shown in more detail in FIG. 8. The delivery option is then selected, as shown at 44, and more specifically for certain items, as an example, in FIG. 9. Next in the process, an E-mail is sent to the seller to confirm delivery of the item, either to the purchaser or a renter, as represented at 46.

The system is carried out with a computer program control, shown generally at 31, controlling all of the elements of FIG. 1. The information provided above and in the figures enables one skilled in the art to produce a program capable of operating the system. The system is capable of updating all of the information in real time.

The website does feature a front page (FIG. 2) with a “search base”, a rental pool, classifieds, the on-line store, a new user, member log-in for stagers, designers and affiliates. In the present system, the warehouse works directly with the on-line website as inventory is logged in and out of the system. The inventory system is connected to the bookkeeping system and billing system, which is automated. The only manual operation is the warehouse team, which physically moves the furniture, and the person responsible for logging it into the on-line system.

Various staging companies, designers, realtors, homeowners and the general public can utilize the system efficiently through the various membership levels outlined above. The system is easy to use, providing a smoother, simpler process for accomplishing their business goals. The resale aspect of the system is a resource for those who want to buy or sell furniture and accessories easily and conveniently, and further, to have convenient access to quality, lightly used furniture and accessories for sale within the system.

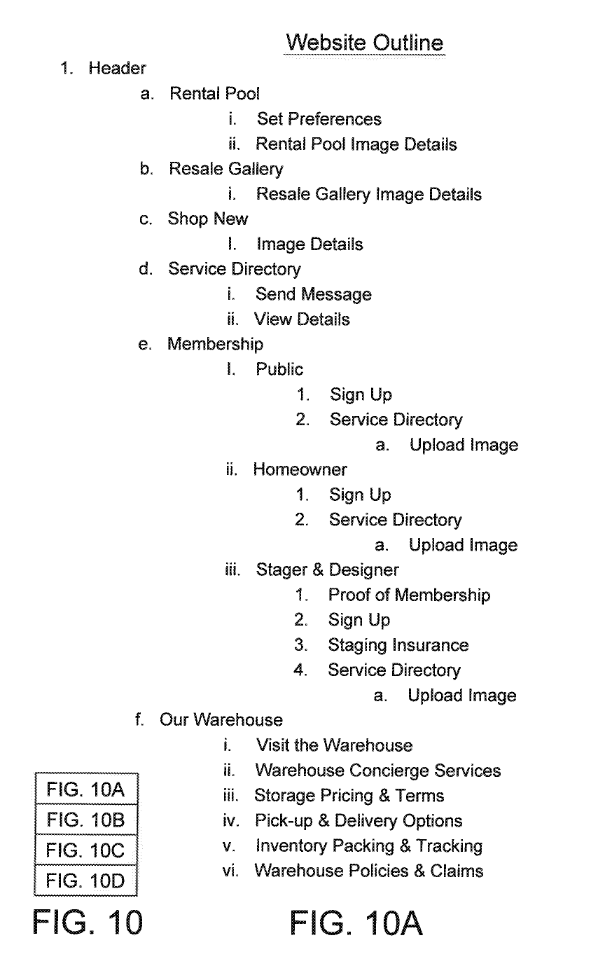

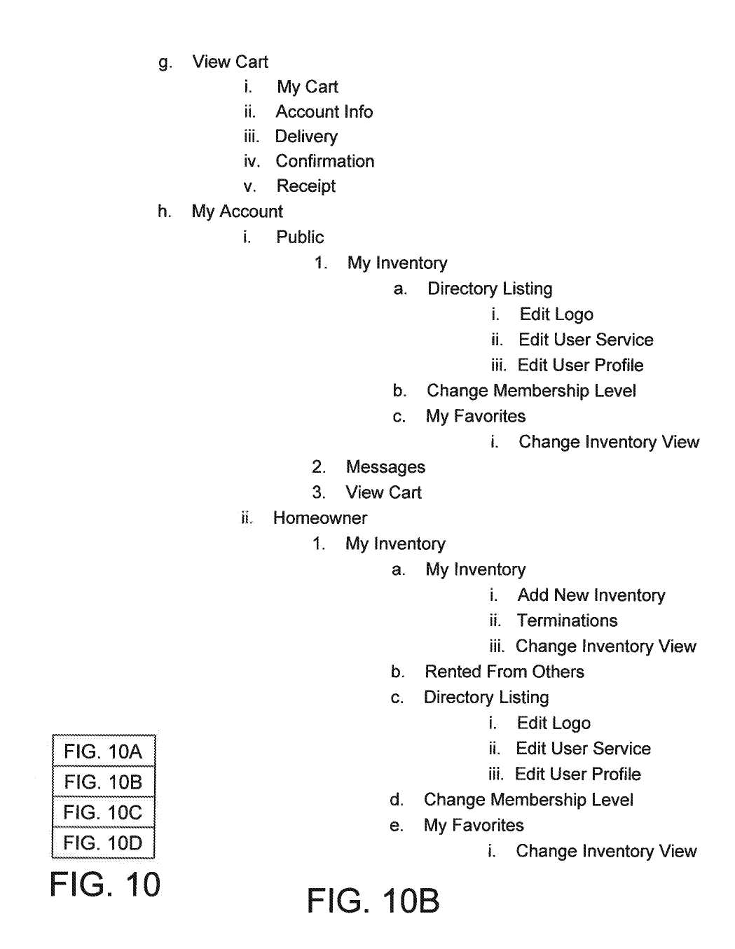

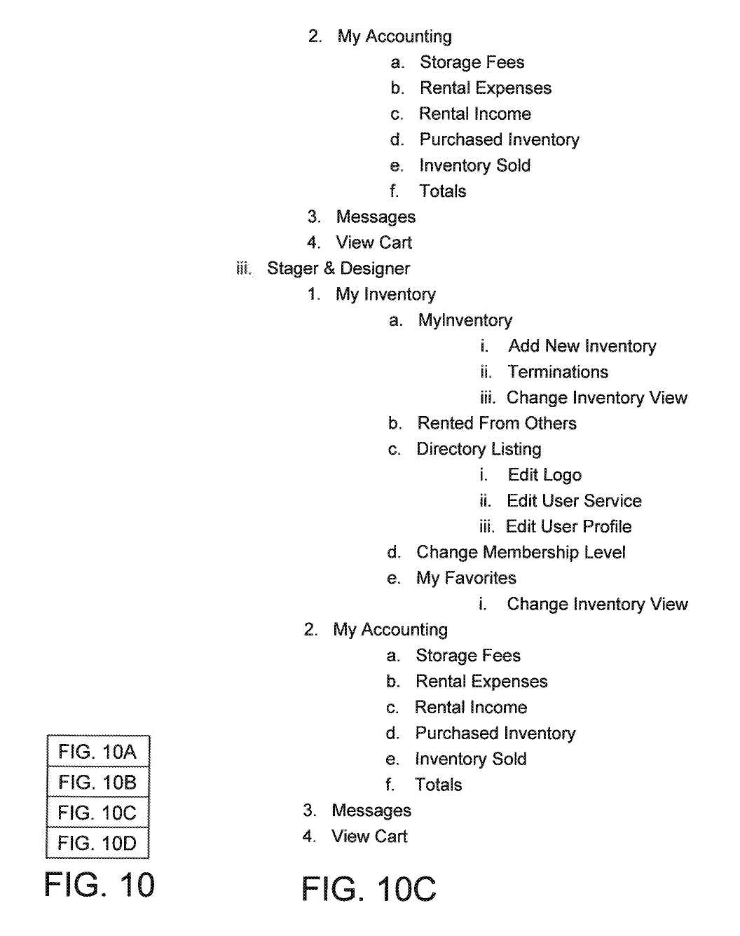

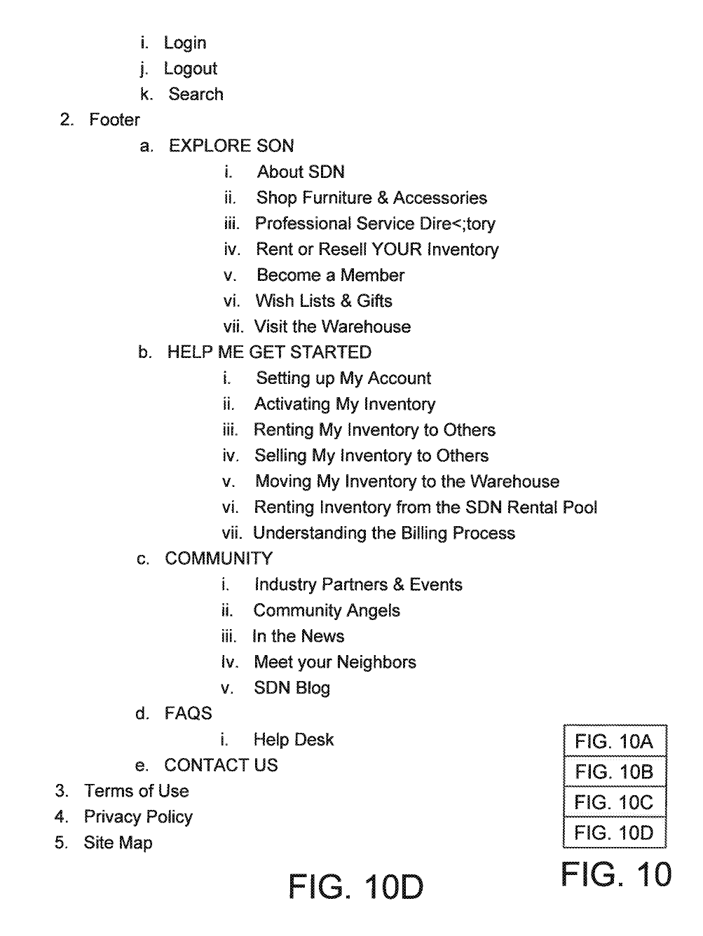

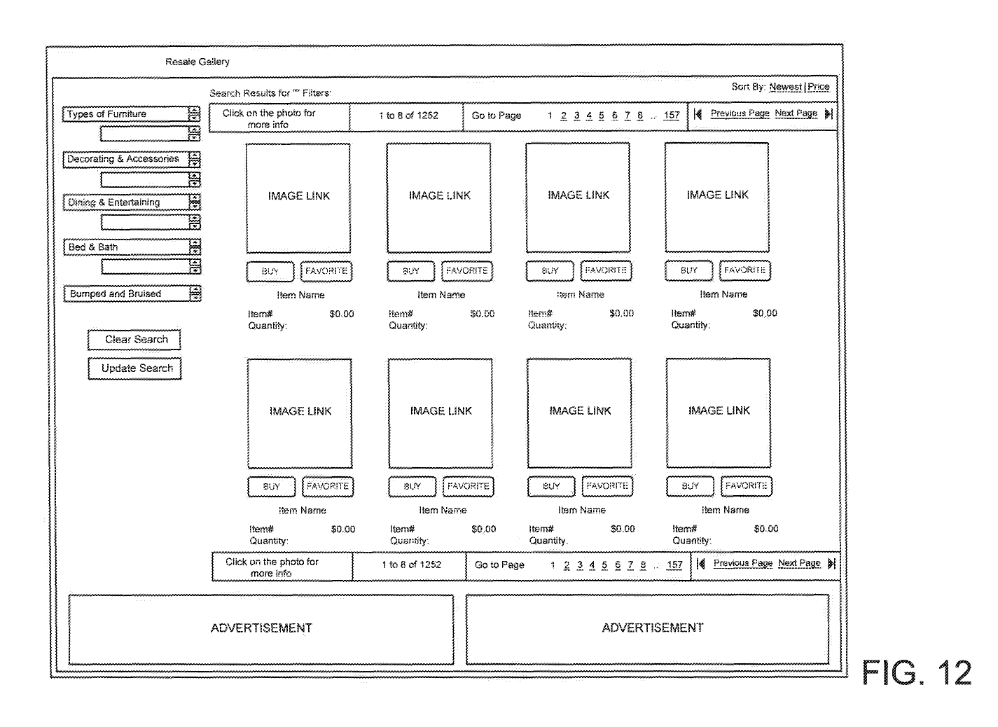

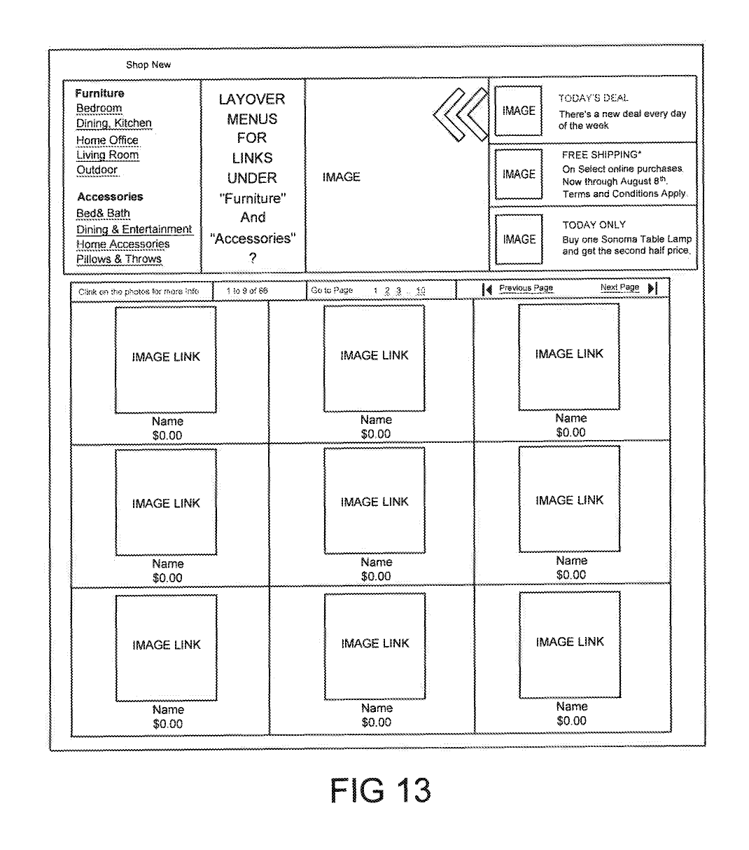

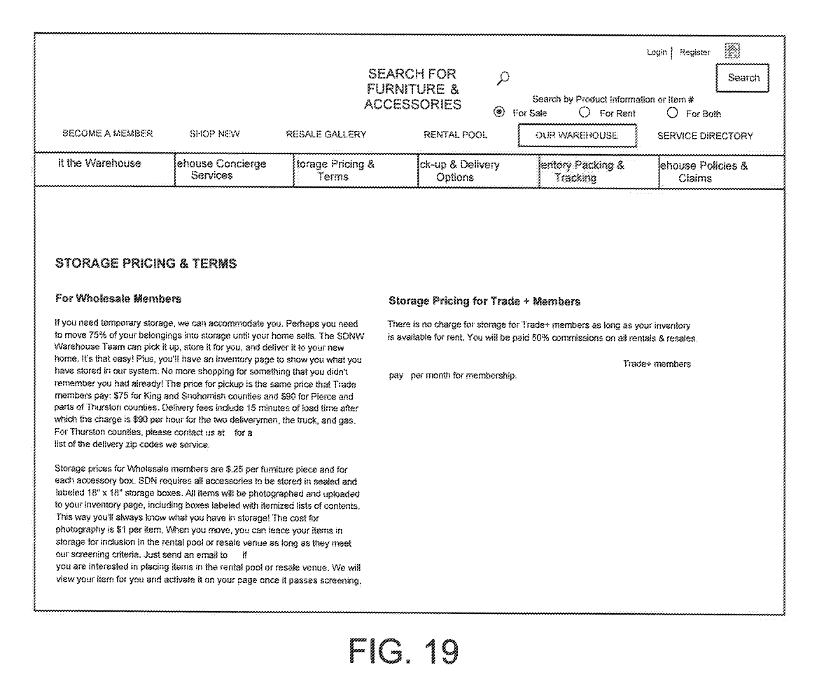

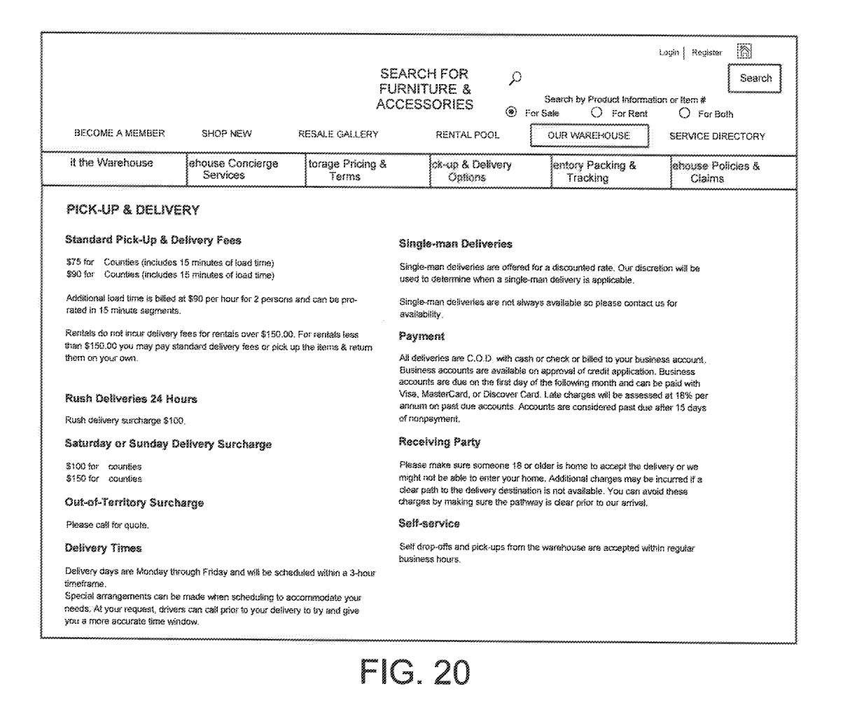

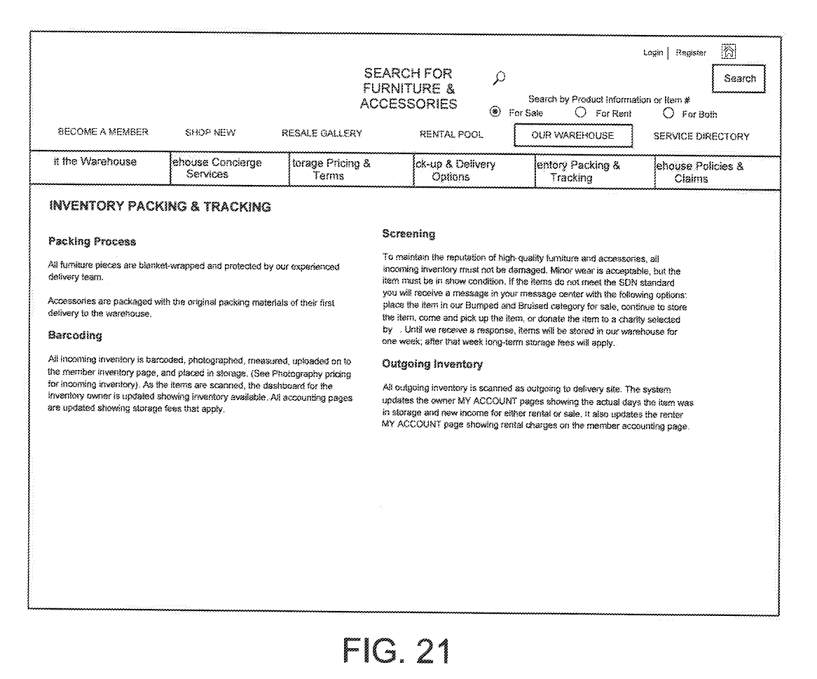

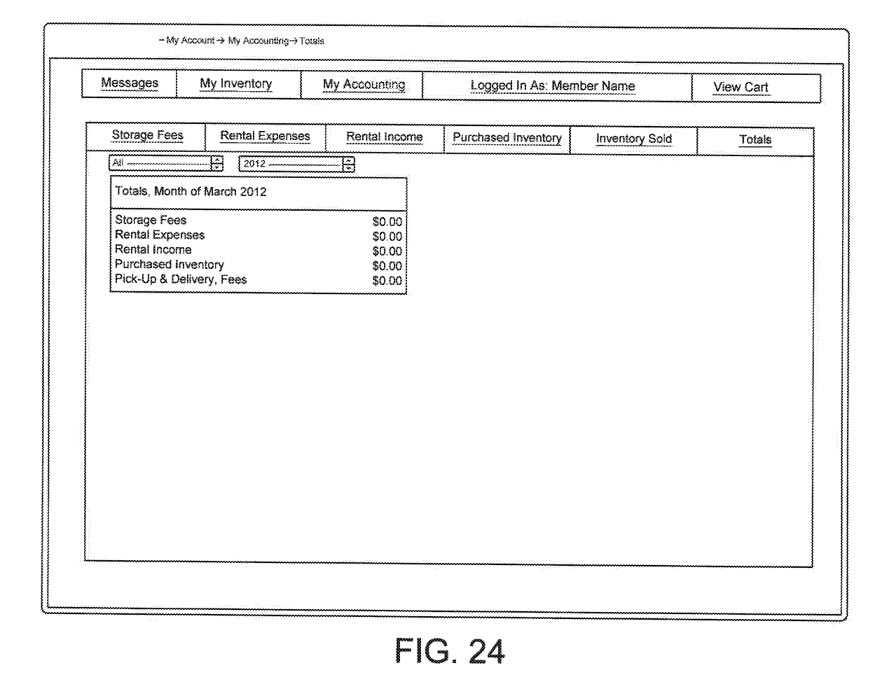

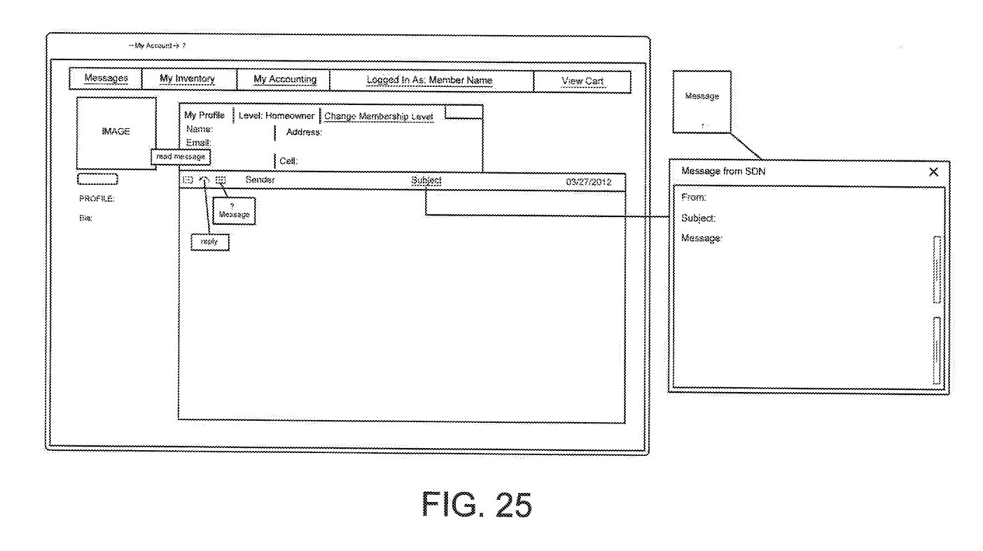

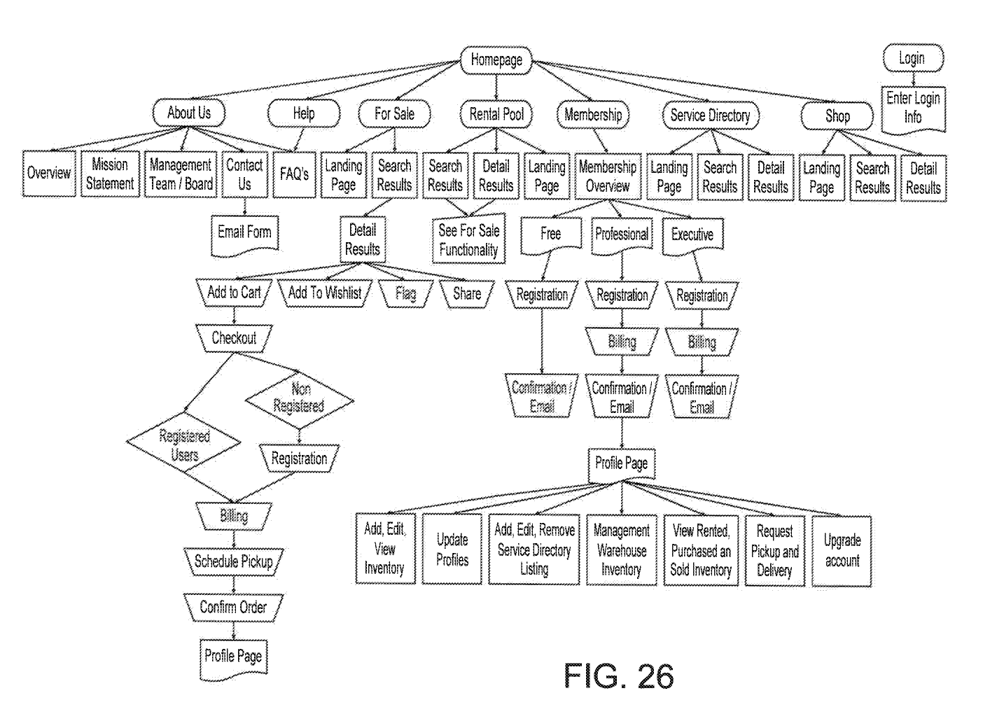

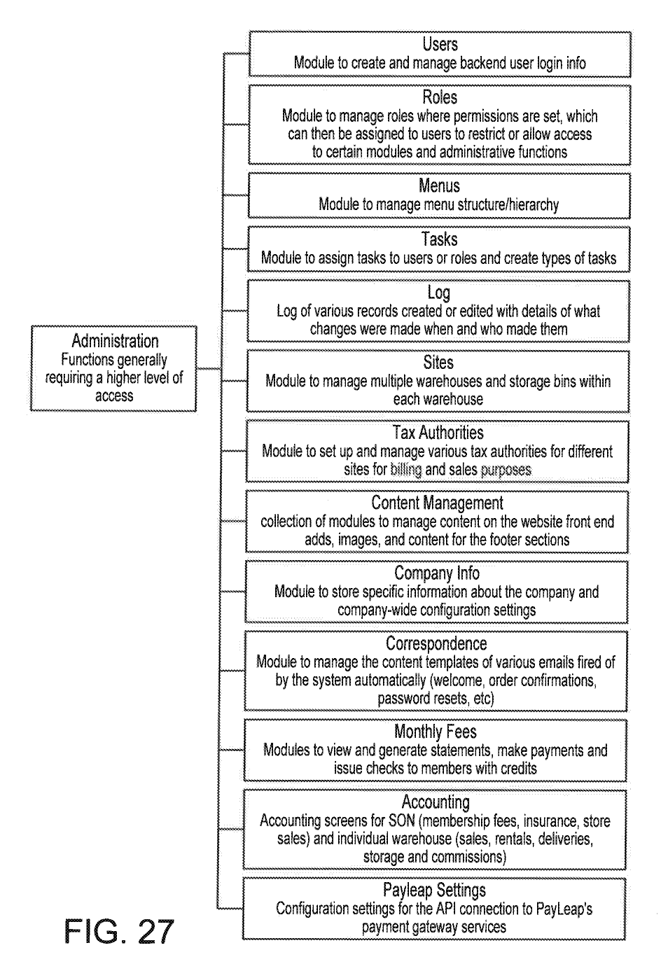

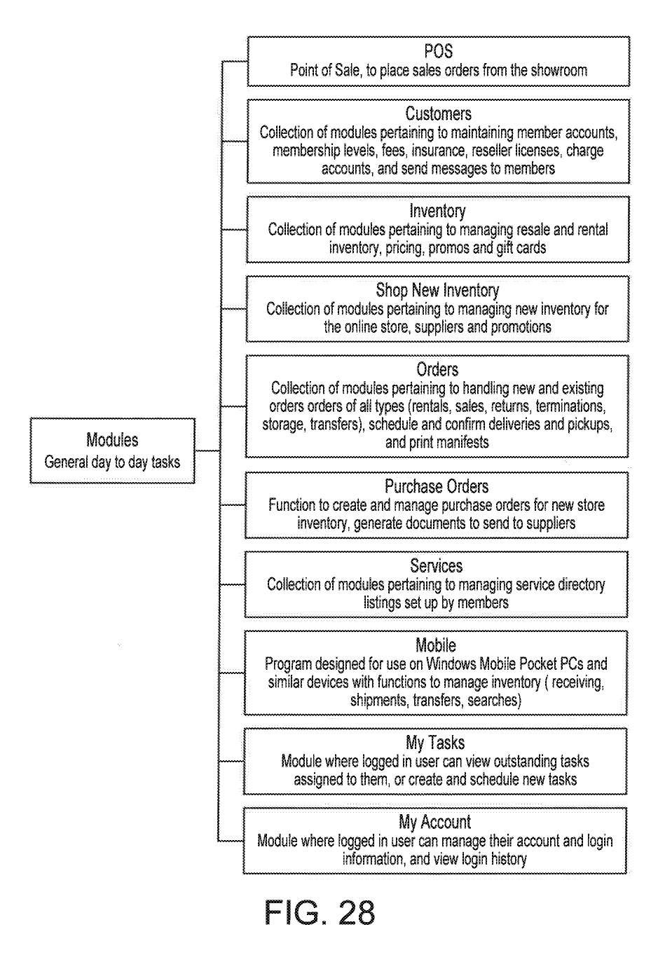

FIGS. 10-28 provide additional information for the present invention. Membership information can include three different categories, each referred to by a particular name. In FIG. 10, membership is characterized in public, homeowner, stager and designer categories; other sets of names can include, for instance, free, wholesale or trade, wherein the trade category can be upgraded with further benefits.

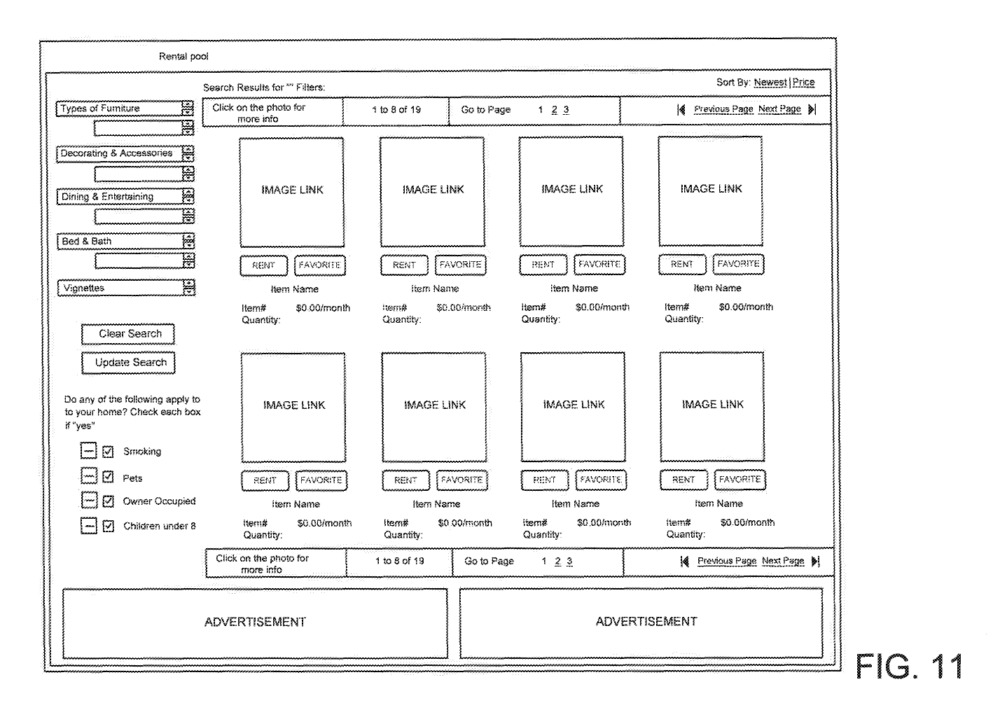

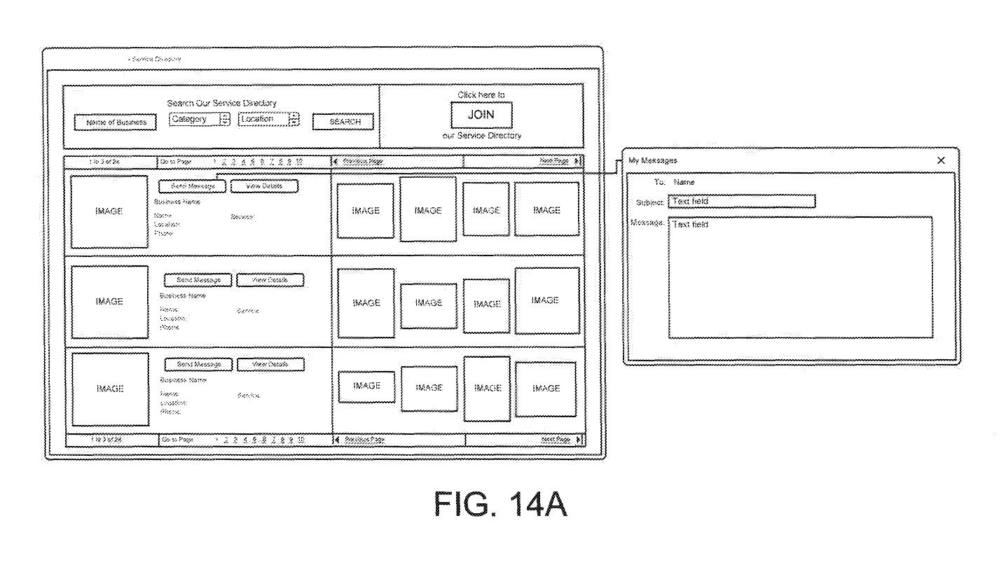

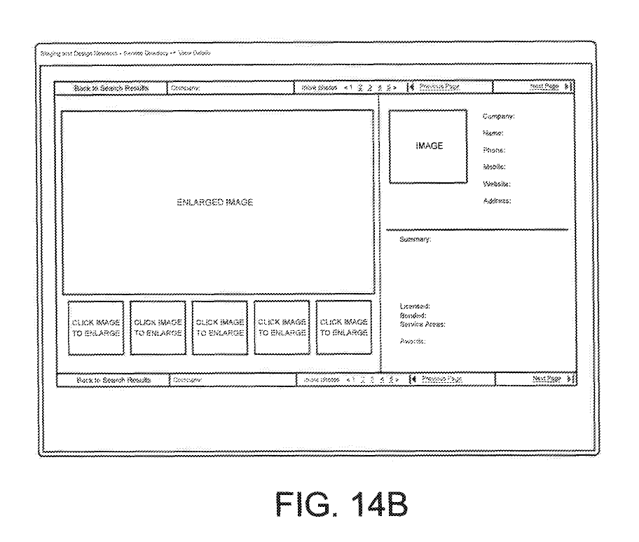

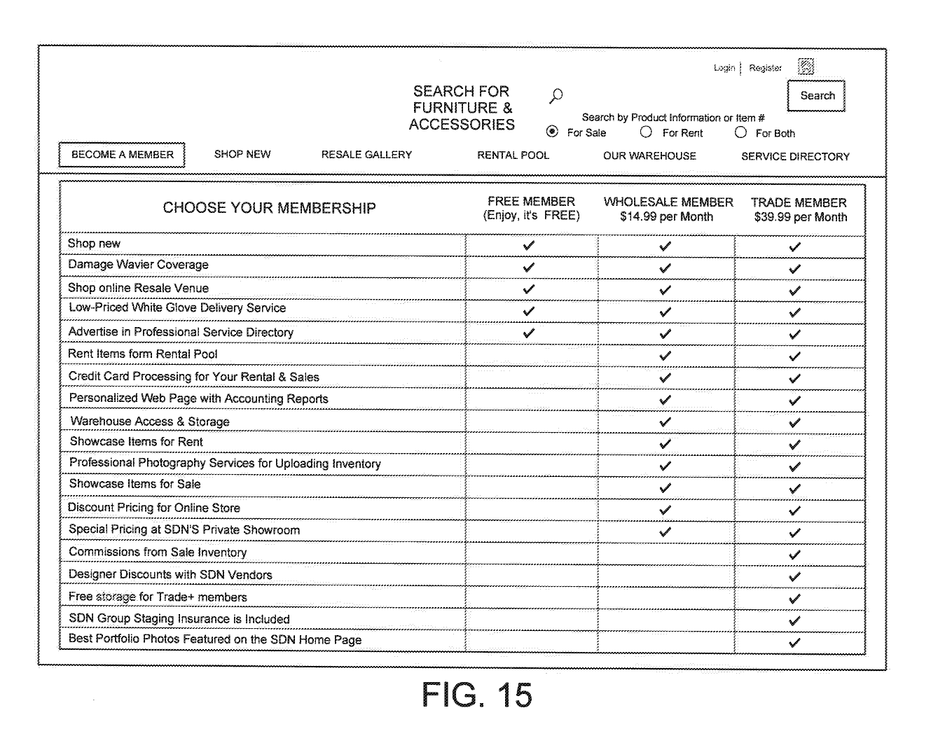

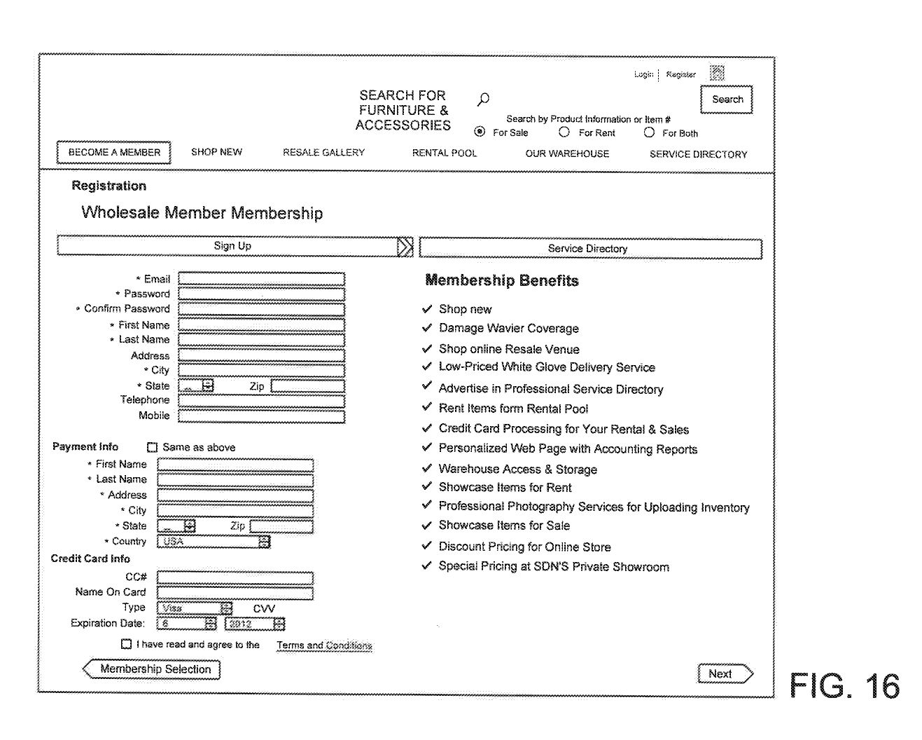

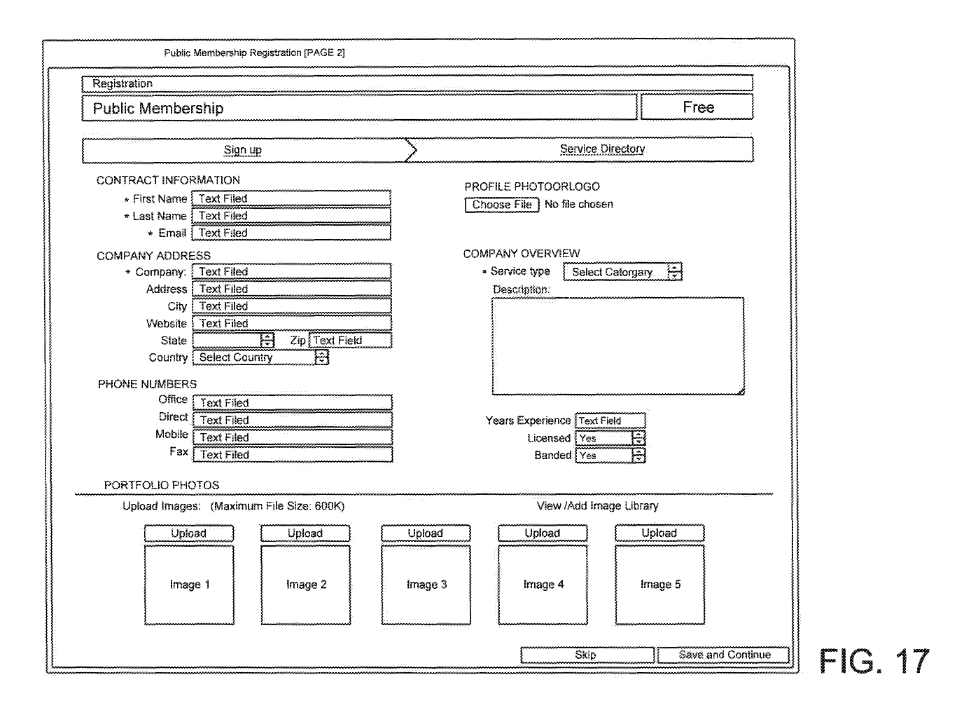

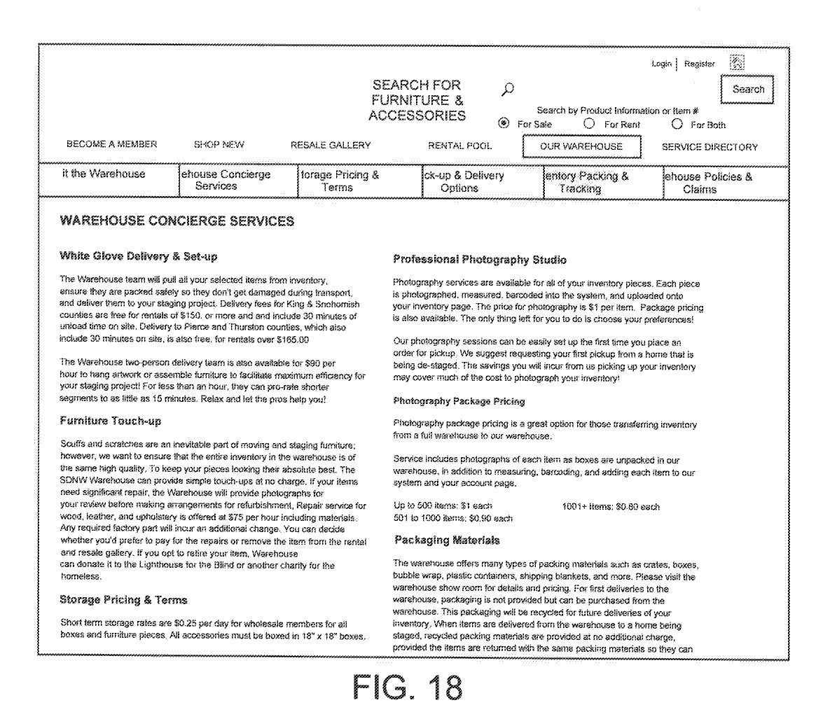

The website is divided into several different sections, and again referring to FIG. 10, the primary divisions are a header portion and a footer portion. The website organization shown in FIG. 10 is provided and controlled by the computer program/software shown at 31 in FIG. 1. The information provided herein, including the figures, is sufficient, on a high level, to enable a typical programmer to produce a code which is capable of carrying out the functions disclosed herein. The header portion includes information concerning the inventory available for rental, inventory available for resale, and inventory which is new and available for sale. Examples of screens on the website are shown in FIGS. 11-13. A service directory information screen is shown in FIG. 14. Membership benefits shown in screens on the website for three categories of membership are shown in FIG. 15, while two sample membership application screens are shown in FIGS. 16 and 17. Warehouse information listed in FIG. 10 is shown in website screens in FIGS. 18-21 for use by members for the on-line system.

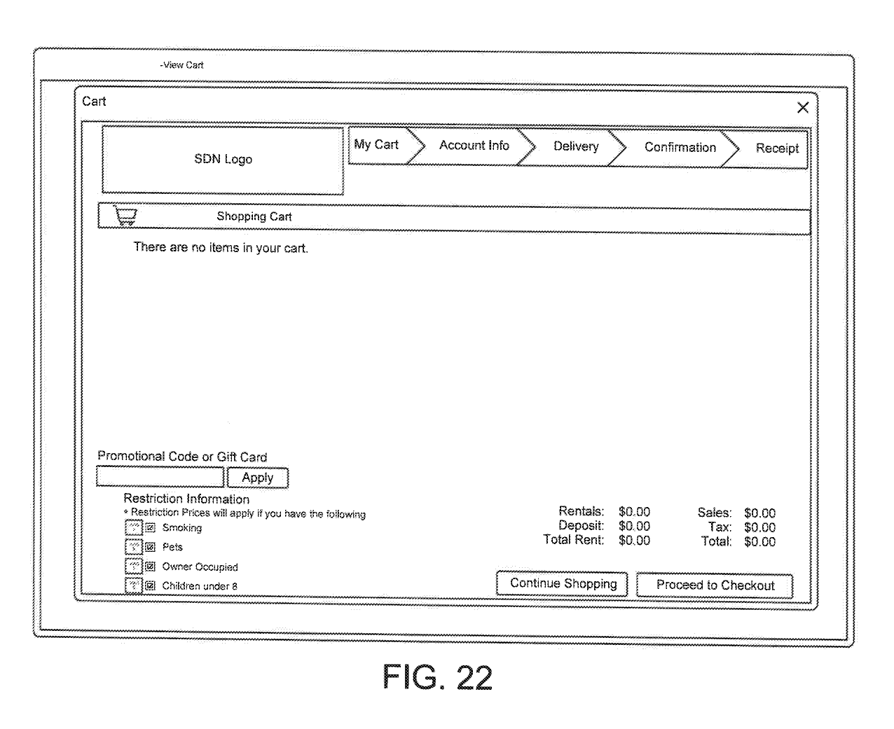

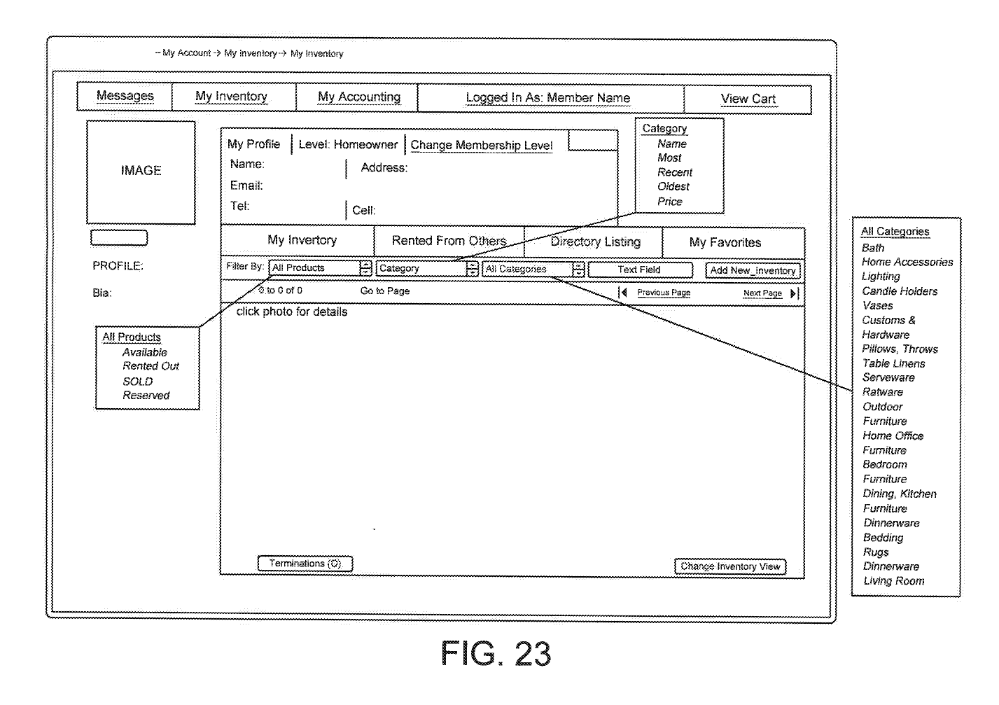

From FIG. 10, the website also has a view cart function which includes screens for items i-v, with i being shown in FIG. 22 as an example. Similar screens are provided for items u-v. From FIG. 10, the website also includes account information for the three levels of membership. For the public or free level, account information includes inventory, messages and view cart screens, with additional screens in accordance with FIG. 10 being provided. The homeowner/wholesale membership category includes inventory, account, messages and view cart information screens, with inventory and account information including additional specific information screens, for particular information listed in FIG. 10. The same is true for the third category of membership, stager and designer or trade. FIGS. 23-25 show sample screens for inventory and accounting for the second and third levels of membership.

One important feature for both the homeowner/wholesale and stage and designer/trade levels is that discounts are provided for transactions, in the on-line (website) store, as opposed to on-site warehouse (brick and mortar) transactions. The discounts are somewhat larger in the trade than the wholesale levels, with the discounts typically between 40-60%, although this can be varied.

The remaining portions of the header section of the website are simply login/logout and search functions.

In the footer portion of the website, provided by the software, there is information about the overall website, basic information about the inventory and information about community information. The website includes terms of use and privacy policy and a site map for navigating the website.

As indicated above, original FIGS. 1-9 and the above description are sufficient to enable an ordinary skilled programmer to produce a code to accomplish the functionality of the overall system. FIGS. 10-28 provide additional information to assist the skilled programmer to arrive at the suitable code. The complete code is not included with this application, because it is not necessary for an adequate disclosure of the invention and would simply make the resultant patent too lengthy.

It should be noted that while the above on-line inventory system is described in the operating context of stagers and designers, it should be understood that the system can also be applied to other on-line and store-based inventory systems where the system includes levels of memberships, and where inventory items are stored in a warehouse and can be rented for short periods of time and/or stored or sold to meet the particular needs of the individual members.

Although a preferred embodiment of the invention has been disclosed for purposes of illustration, it should be understood that various changes, modifications and substitutions may be incorporated in the embodiment without departing from the spirit of the invention.

1. An online membership-based inventory system, enabling storage, rental and/or sale of inventory items therein for members, comprising:
a processor operating with a stored software program;
a membership portion operated by the processor for receiving and accepting membership applications;
a warehouse for storing inventory items;
a warehouse inventory portion operated by the processor for storing information concerning inventory items available to the members from the warehouse;
a communication portion operated by the processor enabling the members to access the stored inventory information and to select and order items from the warehouse inventory for rental and/or purchase and/or to store inventory items in the warehouse; and
an accounting portion operated by the processor for tracking information concerning rentals and/or purchases of inventory items from the warehouse inventory by the members, and/or storage of inventory items in the warehouse.

2. The system of claim 1, wherein the inventory items include furniture and accessories for stagers and designers.

3. The system of claim 1, including multiple levels of membership, each membership having different services available to it in the inventory system.

4. The system of claim 1, wherein the warehouse inventory portion includes inventory items for rental and/or sale to members and from members.

5. The system of claim 1, wherein the warehouse inventory portion includes inventory pickup and delivery information and inventory tracking information.

6. The system of claim 1, wherein the system includes the capability of a member viewing on-line their selection of rental and/or sale inventory items in the form of a cart screen.

7. The system of claim 1, wherein the system provides information to members concerning storage and/or use of inventory items by those members.

8. The system of claim 1, wherein the system is adapted to permit members to change their level of membership.

9. The system of claim 1, wherein the member in at least one membership level receives a discount for rental/purchase of inventory items on-line.

10. The system of claim 1, wherein members in at least one membership level can provide inventory items to the warehouse for rental and/or sale to other members.

11. The system of claim 1, wherein the accounting portion includes information concerning use of the system by members.

12. The system of claim 1, wherein the system includes a new inventory portion for managing new inventory to the warehouse and the warehouse inventory portion.
